(19) United States
(12) Patent Application Publication
(10) Pub. No.: US 2022/0200945 A1
(43) Pub. Date: Jun. 23, 2022

(54) COMMENT MODERATION

(71) Applicant: Meta Platforms, Inc., Menlo Park, CA (US)

(72) Inventors: Melissa Erin Summers, Charlotte, NC (US); Henry Tsai, San Francisco, CA (US); Nan Li, Palo Alto, CA (US); Amey Ajit Porobo Dharwadker, San Jose, CA (US); Kirill A. Pugin, Bellevue, WA (US); Sammy El Ghazzal, Oberengstringen (CH)

(21) Appl. No.: 17/555,090

(22) Filed: Dec. 17, 2021

Related U.S. Application Data
(60) Provisional application No. 63/129,381, filed on Dec. 22, 2020.
(60) Provisional application No. 63/132,383, filed on Dec. 30, 2020.
(60) Provisional application No. 63/148,393, filed on Feb. 11, 2021.
(60) Provisional application No. 63/137,513, filed on Jan. 14, 2021.

(51) Int. Cl. H04L 51/52; H04L 51/00

(52) U.S. Cl. CPC H04L 51/32; G06Q 50/01; H04L 51/14; H04L 51/12

(57) ABSTRACT

The disclosed technology can provide tools to choose who can provide comments and tools to hide comments. A public figure, such as a verified public figure, can select who is permitted to comment on a post by the public figure subject to certain restrictions that promote open public dialogue. Any user, apart from a public figure, also can select who is permitted to comment on their public posts. Further, how a comment to a post is viewed can be based on a type of viewer, a type of action taken on the comment, and a type of actor who takes action on the comment. A plurality of comments can be hidden and removed from an original listing of comments and relocated to a separate area created for hidden comments.

### CROSS-REFERENCE TO RELATED APPLICATIONS

This application claims priority to U.S. Provisional Patent Application No. 63/129,381, filed on Dec. 22, 2020 and entitled “COMMENT MODERATION”, U.S. Provisional Patent Application No. 63/132,383, filed on Dec. 30, 2020 and entitled “INTEREST GRANULARITY AND EXPANSION FOR PERSONALIZED VIDEO RECOMMENDATIONS”, U.S. Provisional Patent Application No. 63/148,393, filed on Feb. 11, 2021 and entitled “CONTEXT BASED GROUP NAMING AND MESSAGE GROUPER AND SUMMARIZER”, and U.S. Provisional Patent Application No. 63/137,513, filed on Jan. 14, 2021 and entitled “ADAPTIVE BITRATE VIDEO DELIVERY”, all of which are incorporated herein by reference in their entireties.

### FIELD OF THE INVENTION

The present technology relates to networking systems. More particularly, the present technology relates to communications in networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system may provide resources through which users may publish content items. In one example, a content item can be presented on a profile page of a user. As another example, a content item can be presented through a feed for a user to access. Users may provide feedback associated with a content item, for example, through comments, reactions, etc.

### SUMMARY

Various embodiments of the present technology can include systems, methods, and non-transitory computer readable media configured to determine, by a computing system, a type of viewer selected by an owner of a post; determine, by the computing system, a type of owner associated with the owner of the post; and determine, by the computing system, a viewer can provide a comment to the post based on the type of viewer and the type of owner.

In some embodiments, the type of owner includes a blue badge public figure or a non-blue badge public figure and the type of viewer includes at least one of followed profile or page, tagged profile or page, or blue badge public figure.

In some embodiments, the systems, methods, and non-transitory computer readable media are further configured to determine, by the computing system, a type of action taken on the comment by a type of actor; and provide, by the computing system, a type of view of the comment based on the type of viewer, the type of action, and the type of actor.

In some embodiments, the type of view is at least one of visible on separate surface, no effect, remove feature, remove delete for blue badge comments, or comment deleted.

In some embodiments, the systems, methods, and non-transitory computer readable media are further configured to provide, by the computing system, an option to hide comments in a first listing; and relocate, by the computing system, the comments from the first listing to a second listing of hidden comments.

Various embodiments of the present technology can include systems, methods, and non-transitory computer readable media configured to determine, by a computing system, a content tag associated with a content item accessed by a user; generate, by the computing system, an embedding associated with the content tag; and determine, by the computing system, an interest associated with the user based on the embedding.

In some embodiments, the interest associated with the user is determined further based on a level of granularity associated with the content tag.

In some embodiments, the interest associated with the user is determined further based on a watch time associated with the content item accessed by the user.

In some embodiments, the systems, methods, and non-transitory computer readable media are further configured to generate, by the computing system, a set of candidate recommendations based on the interest associated with the user; rank, by the computing system, the set of candidate recommendations based on a weighted user engagement associated with the content item accessed by the user; and provide, by the computing system, a recommendation based on the ranking.

In some embodiments, the generating of the embedding associated with the content tag comprises: training, by the computing system, a model based on training pairs of content tags and co-occurrences associated with the training pairs of content tags.

Various embodiments of the present technology can include systems, methods, and non-transitory computer readable media configured to determine, by a computing system, contexts associated with a user that has created a messaging group; generate, by the computing system, a recommendation for a name to apply to the messaging group based on the contexts associated with the user; and provide, by the computing system, the recommendations to the user.

In some embodiments, the systems, methods, and non-transitory computer readable media are further configured to determine, by the computing system, contexts associated with other users added to the messaging group, wherein the recommendation for the name to apply to the messaging group is further based on the contexts associated with the other users.

In some embodiments, the systems, methods, and non-transitory computer readable media are further configured to determine, by the computing system, one or more messages exchanged in the messaging group, wherein the recommendation for the name to apply to the messaging group is further based on the one or more messages.

In some embodiments, the generating the recommendation for the name is based on a machine learning model, wherein the machine learning model is trained based on contexts associated with past messaging groups and names applied to the past messaging groups.

In some embodiments, the machine learning model is further trained based on contexts associated with past messaging groups created by the user and names applied to the past messaging groups created by the user.

It should be appreciated that many other features, applications, embodiments, and/or variations of the present technology will be apparent from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example screen that can allow selection of types of entities permitted to comment on a post, according to an embodiment of the present disclosure.

FIG. 2 illustrates an example screen that can allow a public figure to select from certain types of entities, according to an embodiment of the present disclosure.

FIG. 3 illustrates an example screen that can allow a user to set what types of entities can comment on public posts.

FIG. 4 illustrates an example screen that can allow a user to select from certain entities, according to an embodiment of the present disclosure.

FIG. 5 illustrates an example screen that allows a user to hide a comment, according to an embodiment of the present disclosure.

FIG. 6 illustrates an example screen in which a comment appears hidden to a user who hid the comment but is still visible to a person who wrote the comment, according to an embodiment of the present disclosure.

FIG. 7 illustrates an example screen through which a user can unhide a previously hidden comment, according to an embodiment of the present disclosure.

FIG. 8 illustrates an example screen to allow a manager or an administrator of a page to hide and move certain comments, according to an embodiment of the present disclosure.

FIG. 9 illustrates an example screen that can include a separate area that provides a listing of hidden comments, according to an embodiment of the present disclosure.

FIG. 10 illustrates an example screen that provides a listing of comments, according to an embodiment of the present disclosure.

FIG. 11 illustrates an example screen that can prompt the user to confirm that the user intends for the multiple comments to be hidden, according to an embodiment of the present disclosure.

FIG. 12 illustrates an example user experience flow for creating a messaging group, according to an embodiment of the present disclosure.

FIG. 13 illustrates an example diagram for grouping of messages in a chat into applicable conversation threads associated with particular conversation topics, according to an embodiment of the present disclosure.

FIG. 14 illustrates an example diagram involving a client device sending a request for content to a server system, according to an embodiment of the present disclosure.

FIG. 15 illustrates an example diagram involving a system server providing a stream of content to one or more client devices, according to an embodiment of the present disclosure.

FIG. 16 illustrates an example diagram involving switching between streams of content, according to an embodiment of the present disclosure.

FIG. 17 illustrates an example manifest associated with a stream of content, according to an embodiment of the present disclosure.

FIG. 18 illustrates an example diagram involving a client device sending a request for content to a server system and receiving a frame in response to the request, according to an embodiment of the present disclosure.

FIG. 19 illustrates an example diagram involving transmission of multiple frames, according to an embodiment of the present disclosure.

FIG. 20 illustrates an example diagram involving a container with data and associated metadata, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Comment Moderation

Keywords: public figure, blue badge, verified, comment, moderation, hide, hidden, harassment, bullying.

A system, such as a social networking system, can enable communications between a public figure and persons who can provide feedback in response to content provided by the public figure. The content provided by the public figure can include a post. Feedback provided by the persons can include comments in response to the post. Comments provided in response to the post can subject the public figure to bullying and harassment, or otherwise convey inappropriate subject matter.

The technology disclosed herein provides comment moderation tools to address public figure bullying and harassment while protecting civic discourse. The disclosed technology can provide functionality for management of comments provided in response to a post by a public figure. The disclosed technology provides tools to choose who can provide comments to a post. The disclosed technology also provides tools to hide comments to a post.

Choose Who Can Comment—For Blue Badge Pages and Profiles

Some public figures experience consistent, coordinated harassment and brigading attacks. The disclosed technology can allow public figures to limit comments to comments provided by profiles and pages that the public figures follow or tag. The disclosed technology can apply to some or all public figures. In some embodiments, the disclosed technology can be implemented by those public figures who have experienced harassment or brigading attacks and accordingly have chosen to activate or “opt in” to the disclosed technology. In some embodiments, the disclosed technology applies to public figures who are “blue badge” public figures. As used herein, a “blue badge” public figure refers to an organization or person that has been verified as, respectively, an authentic page or profile on a system, such as a social networking system, a collaboration system, a content platform, a communication platform, or the like. To prevent potential abuse, comments from other blue badge public figures can be protected from deletion.

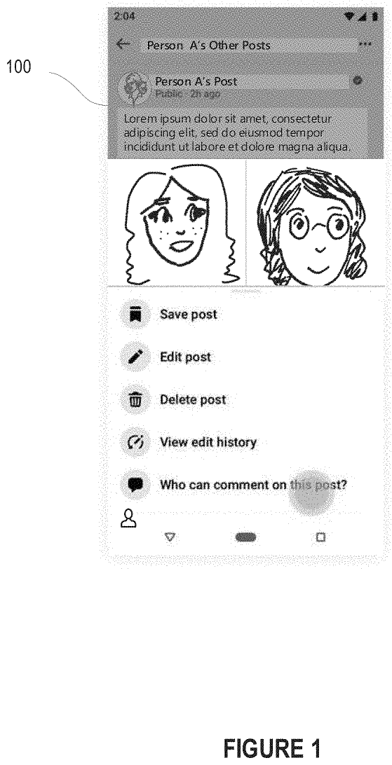

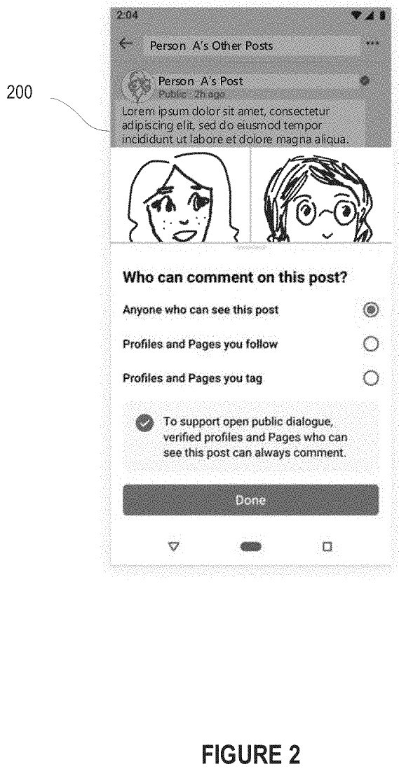

Based on the disclosed technology, a user interface screen displayable through a computing system (e.g., a mobile device or a personal computer) can allow a blue badge public figure to select who is permitted to comment on a post by the blue badge public figure. As shown in FIG. 1, a screen 100 in an embodiment of the disclosed technology can allow a blue badge public figure to select which types of entities are permitted to comment on a post by the blue badge public figure. For example, as shown in FIG. 2, a screen 200 in an embodiment of the disclosed technology can allow the blue badge public figure to select from the following types of entities: anyone who can see the post, profiles and pages followed by the blue badge public figure, and profiles and pages tagged by the blue badge public figure. In other examples, other types of entities can be listed for selection by the blue badge public figure to permit them to comment on a post by the blue badge public figure. However, to prevent abuse of this feature and to support open public dialogue, other blue badge public figures are still able to comment on posts they can see. Comments from other blue badge public figures are protected by allowing the comments to be hidden but not deleted entirely.

Choose Who Can Comment—For Everyone Else (Non-Blue Badge Pages and Profiles)

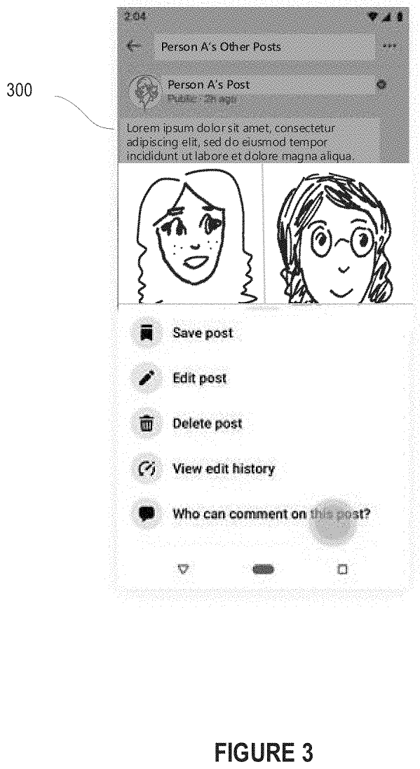

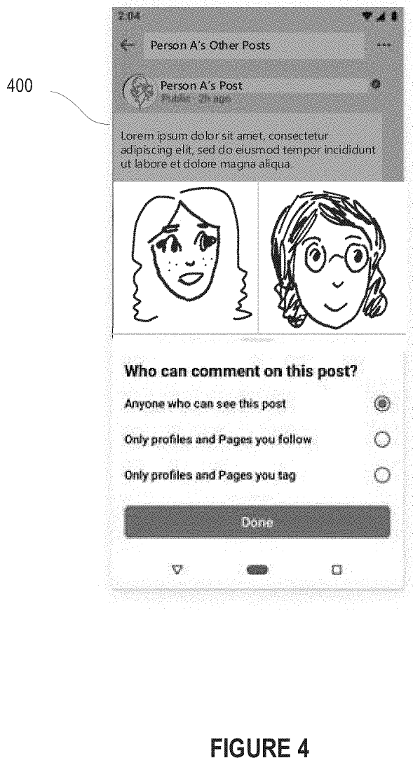

The disclosed technology can prevent coordinated harassment and brigading attacks against a user, apart from a blue badge public figure. As shown in FIG. 3, a screen 300 in an embodiment of the disclosed technology can allow a user, apart from a blue badge public figure, to set what types of entities can comment on public posts by the user. For example, as shown in FIG. 4, a screen 400 in an embodiment of the disclosed technology can allow the user to select from the following types of entities: anyone who can see the post, profiles and pages followed by the user, and profiles and pages tagged by the user. In other examples, other types of entities can be listed for selection by the user to permit them to comment on a post by the user.

Bulk Hiding of Comments

In an embodiment of the disclosed technology, Table 1 indicates how comment management can be implemented. Table 1 indicates various types of actions on comments that can be taken. The various types of actions include hiding a comment and deleting a comment. The various types of actions on comments can be taken by various types of actors. The various types of actors can include a post owner, a bystander, and a commenter. Table 1 also indicates various types of views of a comment for various types of viewers when actions are taken on the comment. The various types of viewers include a post owner, a comment owner, a bystander, and a person who hid the comment. The various types of views include a comment tombstone, no effect, no effect to others, invisible, visible to friends of a commenter, and comment deleted. Many variations are possible.

TABLE 1

| | | | | (4) |
|---|---|---|---|---|
| | | | | Viewed |
| | | (2) | | by |
| | (1) | Viewed | (3) | Person |
| | Viewed | by | Viewed | who hid |
| | by Post | Comment | by | the |
| | Owner | Owner | Bystander | comment |
| (A) Hidden | Comment | No effect | Invisible. | Comment |
| by Post | tombstone | | Visible to | tombstone |
| Owner | | | friends of | |
| | | | Commenter | |
| (B) Hidden | No effect | No effect | No effect to | Comment |
| by | | | others | tombstone |
| Bystander | | | | |

| | |
|---|---|
| (C) Deleted | Comment deleted |
| by Post | |
| Owner | |
| (D) Deleted | i. Users cannot hide their own comments. Only post owners |
| by | and comment owners may delete a comment on the post |
| Commenter | ii. Ads provide the same experience |

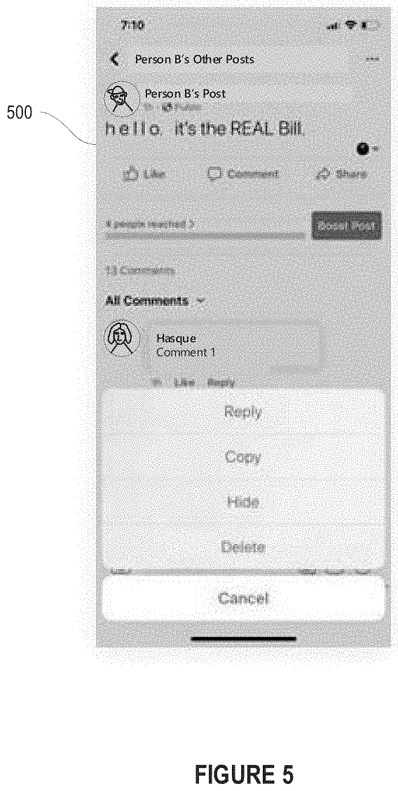

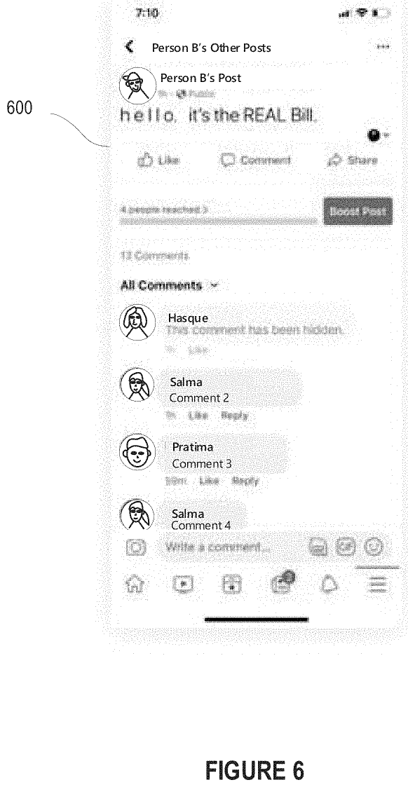

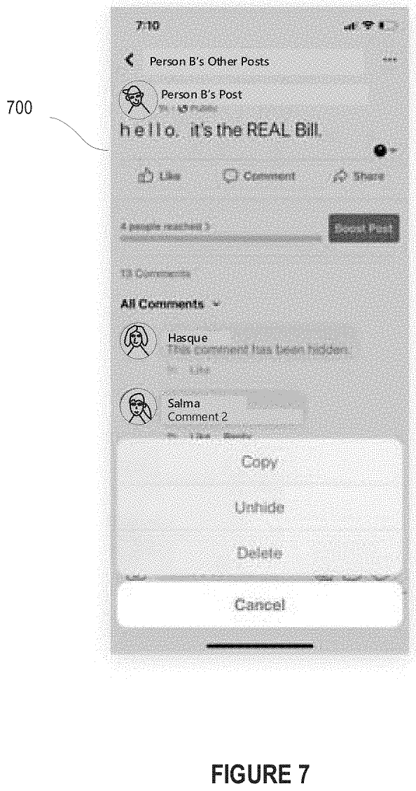

FIG. 5 illustrates a screen 500 in an embodiment of the disclosed technology that allows a user, such as a post owner or a bystander, to hide a comment. For example, a post owner or a bystander can select a comment to display various actions that can be taken on the comment. For example, the post owner or the bystander can long press the comment and select an option to hide the comment. FIG. 6 illustrates a screen 600 in an embodiment of the disclosed technology in which a comment appears hidden to a user who hid the comment but is still visible to a person who wrote the comment and visible to connections (e.g., friends) of the person. FIG. 7 illustrates a screen 700 in an embodiment of the disclosed technology through which a user can unhide a previously hidden comment. For example, the user can select the comment to display various actions that can be taken on the comment. For example, the user can long press the comment and select an option to unhide the comment.

In an embodiment of the disclosed technology, Table 2 indicates how comment management can be implemented. Table 2 indicates various types of actions on comments that can be taken. The various types of actions include hiding a comment and deleting a comment. The various types of actions on comments can be taken by various types of actors. The various types of actors can include a post owner, a bystander, and a commenter. Table 2 also indicates various types of views of a comment for various types of viewers when actions are taken on the comment. The various types of viewers include a post owner, a comment owner, a bystander, and a person who hid a comment. The various types of views include visible on separate surface, no effect, remove feature, remove delete for blue badge comments, and comment deleted. Many variations are possible.

When actions are taken on a comment, some types of views of the comment for various types of entities in Table 2 are different from and represent an improvement to Table 1. In this regard, when a comment to a post is hidden by the post owner in Table 2, the comment can be visible on a separate surface by the post owner, a bystander, and a person who hid the comment. When a comment to a post is hidden by a bystander in Table 2, the feature can be removed because it has no effect or relevant use cases. When a comment to a post is deleted by the post owner in Table 2, the ability to delete blue badge comments on public posts is removed to prevent silencing of notable counter speech.

TABLE 2

| | | | | (4) |
|---|---|---|---|---|
| | | | | Viewed |
| | | (2) | | by |
| | (1) | Viewed | (3) | Person |
| | Viewed | by | Viewed | who hid |
| | by Post | Comment | by | the |
| | Owner | Owner | Bystander | comment |
| (A) | Visible | No effect | Visible | Visible |
| Hidden by | on | | on | separate |
| Post | separate | | separate | surface |
| Owner | surface | | surface | |

| | |
|---|---|
| (B) | Remove feature because it has no effect |
| Hidden by | or relevant use cases |
| Bystander | |
| (C) | Remove delete for blue badge comments on public |
| Deleted | posts to prevent of silencing notable counter speech. |
| by Post | |
| Owner | |
| (D) | Comment deleted |
| Deleted | |
| by | |
| Comment | |
| Owner | |

Hidden Comment Menu and Transparency

In some instances, the hide feature allowing comments to be hidden can be confusing for users and does not house a permanent place where people can see all hidden comments. Accordingly, a dedicated section in an embodiment of the disclosed technology can be created to place hidden comments. The creation of the dedicated section can serve as a transparency guardrail.

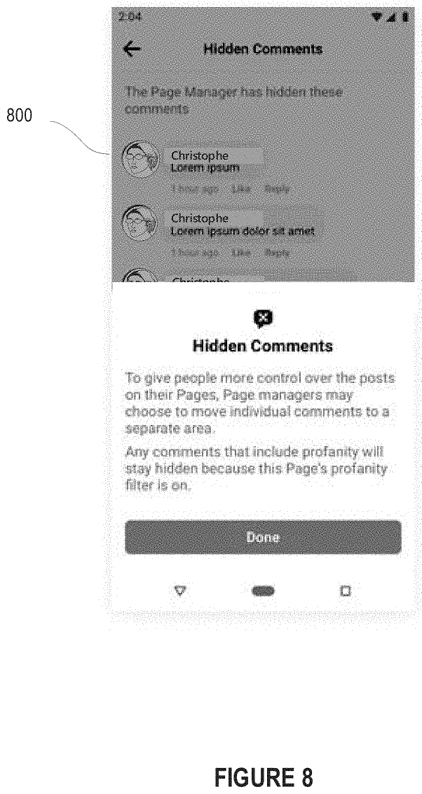

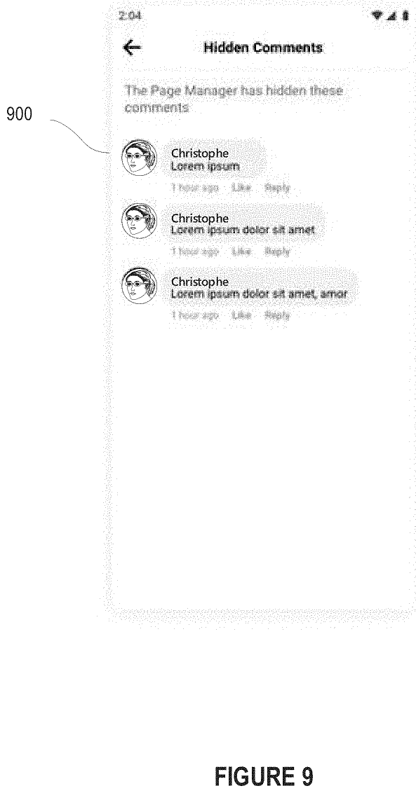

FIG. 8 illustrates a screen 800 in an embodiment of the disclosed technology to allow a manager or an administrator of a page to hide and move certain comments to a separate surface or area. For example, individual comments selected by a page manager can be manually hidden and selected for removal from an original listing of comments and placed in a separate area. In another example, types of comments selected by a page manager can be automatically hidden and relocated to a separate area. In some instances, a page manager can select that all comments including profanity will be automatically hidden and removed from an original listing and placed in a separate area. For example, FIG. 9 illustrates a screen 900 in an embodiment of the disclosed technology that can include a separate area that provides a listing of hidden comments.

Bulk Hide Functionality

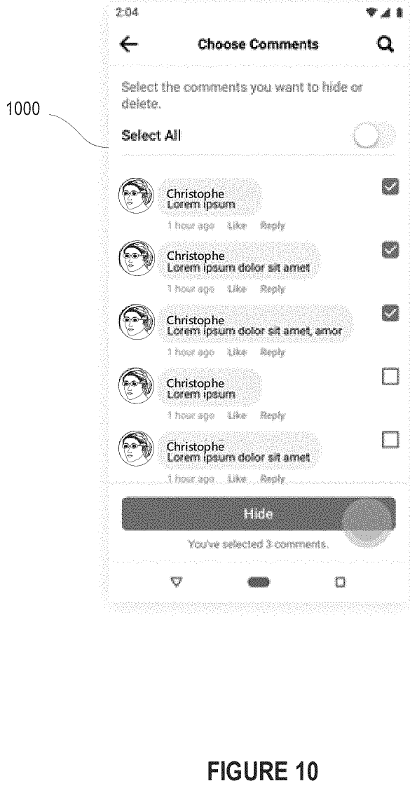

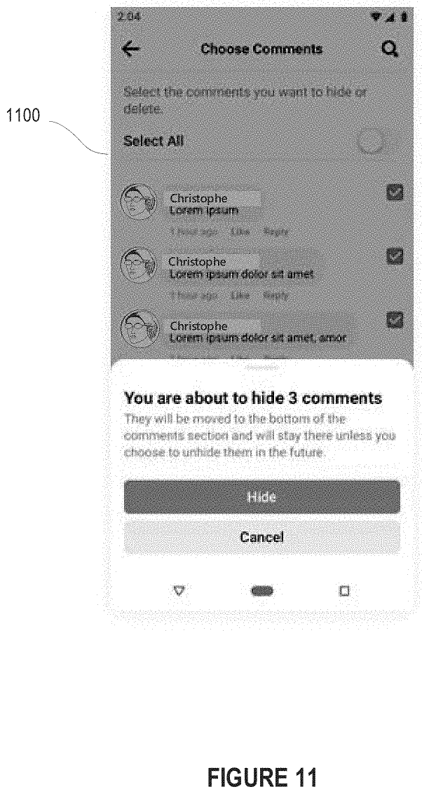

To provide tools which prevent coordinated harassment of and brigading attacks on public figures, the disclosed technology allows users to hide multiple comments. FIG. 10 illustrates a screen 1000 in an embodiment of the disclosed technology that provides a listing of comments. A user can select one or more of the comments in the listing to be hidden. After selection of multiple comments to be hidden, the user through provision of a command (e.g., selection of a “Hide” button) can cause the multiple comments to be hidden. FIG. 11 illustrates a screen 1100 in an embodiment of the disclosed technology that can prompt the user to confirm that the user intends for the multiple comments to be hidden. Upon provision of such confirmation, the multiple comments can be placed or moved to a separate area, such as the bottom of a comments section. The multiple comments can remain in the separate area until the user chooses to unhide some or all of them.

### Interest Granularity and Expansion for Personalized Video Recommendations

Keywords: content tag, video, granularity, user interest, recommendations, embedding.

A system, such as a social networking system, can enable access to content, such as images, videos, articles, and links. The content can be associated with tags that indicate subject matter or topics reflected in the content. For example, a video can be published through a social networking system, and users can access the video through the social networking system. The video can be associated with tags that indicate interests reflected in the video. The interests can include entities (e.g., people, organizations, geographic locations, etc.), topics (e.g., subjects, themes, etc.), and other concepts. For example, a video of a particular athlete can be associated with tags corresponding to the particular athlete, a particular sports team, and other entities reflected in the video. The video can also be associated with tags corresponding to sports, exercise, fitness, and other topics reflected in the video.

The technology disclosed herein provides hierarchical and granular content tagging. The hierarchical and granular content tagging provides for detailed description of content. Further, the hierarchical and granular content tagging reflects an understanding niche interests of users based on their content consumption. For example, understanding the niche interests of the users allows for improved personalization of recommendations for content to provide to the users. Thus, the disclosed technology provides improvements in content tagging, understanding user interests, and personalizing recommendations.

Content Tagging with Poincaré Embeddings

The technology disclosed herein can provide hierarchical and granular content tagging based on a Poincaré model. In general, a Poincaré model embeds representations of data (e.g., Poincaré embeddings) in an embedding space (e.g., an n-dimensional Poincaré sphere). The Poincaré embeddings reflect various interrelationships between the data they represent. The disclosed technology can use a Poincaré model to generate Poincaré embeddings corresponding to content tags. The Poincaré embeddings are mapped to a Poincaré sphere. Based on their mapping in the Poincaré sphere, the Poincaré embeddings reflect interrelationships between their corresponding content tags. These interrelationships can include a hierarchy of the content tags and similarities between the content tags. In an example, Poincaré embeddings that are relatively closer to the center of the Poincaré sphere can correspond to content tags that are associated with interests that are broader than interests that are associated with content tags that correspond to Poincaré embeddings that are relatively farther from the center of the Poincaré sphere. Conversely, Poincaré embeddings that are relatively farther from the center of the Poincaré sphere can correspond to content tags that are associated with interests that are more granular than interests that are associated with content tags that correspond to Poincaré embeddings that are relatively closer to the center of the Poincaré sphere. Poincaré embeddings that are relatively closer to each other can correspond to content tags that are associated with interests that are more similar to each other than interests that are associated with content tags that correspond to Poincaré embeddings that are relatively farther from each other. Conversely, Poincaré embeddings that are relatively farther from each other can correspond to content tags that are associated with interests that are more different from each other than interests that are associated with content tags that correspond to Poincaré embeddings that are relatively closer to each other.

A Poincaré model can be trained to generate Poincaré embeddings based on training data to train a model. The training data can include pairs of content tags and co-occurrences associated with the pairs of content tags. A co-occurrence of a pair of content tags indicates that the pair of content tags are associated with the same content. For example, a video with a first tag “Car Racing” and a second tag “Formula 1” can be considered a co-occurrence of the first tag “Car Racing” and the second tag “Formula 1.” In some cases, a co-occurrence of a pair of content tags can also indicate that a user engaged with content associated with both of the content tags. A pair of content tags that has a relatively higher number of co-occurrences can be considered to be associated with interests that are more similar than interests that are associated with a pair of content tags that has a relatively lower number of co-occurrences. Conversely, a pair of content tags that has a relatively lower number of co-occurrences can be considered to be associated with interests that are more dissimilar than interests that are associated with a pair of content tags that has a relatively higher number of co-occurrences. A content tag that has co-occurrences with a relatively higher number of other content tags can be considered to be associated with an interest that is broader than an interest that is associated with a content tag that that has co-occurrences with a relatively lower number of other content tags. Conversely, a content tag that has co-occurrences with a lower number of other content tags can be considered to be associated with an interest that is more granular than an interest associated with a content tag that has co-occurrences with a higher number of other content tags.

Once trained, a Poincaré model can be used to generate Poincaré embeddings for content tags based on their co-occurrences. The Poincaré embeddings can be used to determine a hierarchy of the content tags and similarities between the content tags. The content tags that are associated with interests that are broader can be higher in the hierarchy of the content tags, and the content tags that are associated with interests that are more granular can be lower in the hierarchy of the content tags. An example table of content tags is provided below.

TABLE 3

| | | Ground | | | | | | | |
|---|---|---|---|---|---|---|---|---|---|
| | Car Racing | Transportation | Wildlife | Wrestling | Reality TV | Beauty | Dance | Video Games | Baking |
| 1 | Motorcycle | Cars | Animal | World | Reality | Makeup & | Reality TV | Action | Desserts & |
| | Racing | | Sightings | Wrestling | Competition | Cosmetics | | Video Games | Sweets |
| | | | & Encounters | Entertainment | TV Shows | | | | |
| | | | | (WWE) | | | | | |
| 2 | Ground | Japanese Cars | Reptiles | Brock Lesnar | Singing | Hair | Music & | Games | Desserts & |
| | Transportation | & Trucks | | | Competition | | Singing | Mobile Apps | Sweets |
| | | | | | TV Shows | | Ensembles | | Recipes & |
| | | | | | | | | | Techniques |
| 3 | Formula 1 | Toyota Cars | Wild Cats | WWE Raw | Music | Lipstick | Pop Music | Strategy | Cakes |
| | | & Trucks | | | Competitions | | | Video Games | |
| 4 | Off-road | Asian Cars | Lions | Sports | Choral & | Jewelry | Western | Consumer | Cupcakes |
| | Motorcycle | & Trucks | | Entertainment | Voice | | Pop | Electronics & | |
| | Racing | | | | Competitions | | | Tech Gadgets | |
| 5 | Cars | European | Deer | Sports | America's Got | Hair Styling | Dance Pop | Multiplayer | Cake |
| | | Cars & Trucks | | Entertainment | Talent (2006- | Tools & | | Games | Decorating |
| | | | | TV Shows | tv series) | Products | | | |
| 6 | Motorcycle | German Cars | Hippopota- | Roman | Western Pop | Hair Cuts & | Informal | Apps & | Birthday |
| | Road Racing | & Trucks | mus | Reigns | | Styles | Musical | Software | Cake |
| | | | | | | | Activities | | |
| 7 | Motorcylces | After-Market | Birds | Seth Rollins | Dance Pop | Clothing & | Comedy | Shooting | Chocolate |
| | | Vehicle | | | | Accessories | | Video Games | |
| | | Accessories | | | | | | | |
| | | & Services | | | | | | | |
| 8 | Small motor | Vehicle | Zoos | Ultimate | American | Makeup | Classical | Role-Playing | Fruits |
| | Vehicles | Support | | Fighting | Idol (2002-tv | Artists | Music | Video Games | |
| | | Services | | Champion | series) | | | | |
| | | | | (UFC) | | | | | |
| 9 | Off-Road | Mid-size Cars | Leopards | John Cena | Contemporary | Makeup | Reality | Children's | Cookies |
| | Racing | | | | Country | Brands | Competition | Entertainment | (food) |
| | | | | | Music | | TV Shows | & Activities | |
| 10 | European | Nissan Cars | Aquariums, | Undertaker | Adult | Crafts | Asian Music | Cars & | Produce |
| | Cars & Trucks | & Trucks | Zoos & Wild- | (WWE | Alternative | | | Trucks | (food) |
| | | | life Parks | Wrestles) | Pop | | | | |
| 11 | Motorcycle | Compact Cars | Alligators, | Becky Lynch | Kelly | Formal Wear | Music | Video Game | Food Art |
| | Events | | Crocodiles & | | Clarkson | | Videos | Streaming | |
| | | | Caimans | | (actor, music | | | | |
| | | | | | artist) | | | | |
| 12 | Supercars | British Cars | Snakes | Charlotte Flair | Simon Cowell | Eye liners | Bollywood | TV & Movies | Ice Cream |
| | | & Trucks | | | | | | by Genre or | |
| | | | | | | | | Theme | |
| 13 | Sports Cars | Supercars | Aquatic | Dean | Hip Hop | Eye Makeup | Adult | Animated TV | Nuts & |
| | | | Animals | Ambrose | Dance | & Cosmetics | Alternative | & Movies | Seeds |
| | | | | | | | Pop | | (food) |
| 14 | German Cars | Sports Cars | Fish (animal) | WWE | Music Videos | Personal | Rock Music | Augmented & | Pastries & |
| | & Trucks | | | SmackDown | | Celebrations | | Virtual | Pies |
| | | | | | | | | Reality | |
| | | | | | | | | Games | |
| 15 | Grand Prix | Sports Utility | Tigers | Ronda Rousey | Classical | Body | Game | Comedy TV | Wedding |
| | Motorcycle | Vehicles | | | Music | Modification | Shows | & Movies | Cakes |
| | Racing | (SUVs) | | | | | | | |
| | (MotoOP, | | | | | | | | |
| | Moto2, M... | | | | | | | | |
| 16 | Japanese Cars | BMW Cars | Primates | Mixed Martial | Informal | Engagements | Hip Hop & | Esports | Food TV |
| | & Trucks | & Trucks | | Arts (MMA) | Musical | & Weddings | Rap music | (Video Game | & Movies |
| | | | | | Activities | | | Competitions) | |

Table 3 provides examples of various content tags. The top row of Table 3 provides examples of content tags associated with broad interests (e.g., Car Racing, Ground Transportation, Wildlife, Wrestling, Reality TV, Beauty, Dance, Video Games, Baking). Below each content tag in the top row, Table 3 provides examples of content tags associated with granular interests. For example, the broad interest “Car Racing” can be associated with granular interests “Motorcycle Racing,” “Ground Transportation,” “Formula 1,” “Off-road Motorcycle Racing,” “Cars,” “Motorcycle Road Racing,” “Motorcycles,” “Small Motor Vehicles,” “Off-Road Racing,” “European Cars & Trucks,” “Motorcycle Events,” “Supercars,” “Sports Cars,” “Sports Cars,” “German Cars & Trucks,” “Grand Prix Motorcycle Racing,” and “Japanese Cars & Trucks.” The granular interests can be associated with more granular interests. In some cases, the granular interests can be associated with different levels of granularity. As an example, a Poincaré embedding corresponding to a content tag for “Car Racing” can be mapped closer to the center of a Poincaré sphere than Poincaré embeddings corresponding to content tags for the granular interests that appear below “Car Racing” in Table 3. Based on different levels of granularity for the interests associated with the content tags for “Motorcycle Racing,” “Ground Transportation,” and “Formula 1”, the Poincaré embeddings corresponding to content tags for “Motorcycle Racing,” “Ground Transportation,” and “Formula 1” can be mapped to varying distances from the center of the Poincaré sphere. The varying distances can correspond to the different levels of granularity for the interests associated with the content tags corresponding to the Poincaré embeddings. For example, the Poincaré embedding for the content tag associated with “Formula 1” can be further from the center of the Poincaré sphere than the Poincaré embedding for the content tag associated with “Motorcycle Racing,” indicating that “Formula 1” is a more granular interest than “Motorcycle Racing.”

Content Tagging for Interest Granularity Understanding

The technology disclosed herein allows for a deeper understanding of user interests. For example, user interests of a user can be determined based on hierarchical and granular content tags associated with content the user consumes and watch times associated with how long the user consumes the content. The content that the user consumes can be associated with content tags that indicate interests reflected in the content. The watch times associated with how long the user consumes the content can indicate an amount of user interest in the interests reflected in the content. The content tags can be associated with different levels of granularity that indicate how broad or how granular the interests associated with the content tags are. More granular content tags generally correlate with more specific or niche user interests of the user. The disclosed technology can determine user interests of a user by identifying granular content tags associated with content the user consumes and comparing interests associated with content tags of the same (or a similar) level of granularity. For example, watch times of a user associated with content the user consumed can indicate that the user spends a large amount of time consuming content with content tags for “Car Racing,” “Formula 1,” “Wildlife,” and “Tigers.” In this example, the content tags for “Formula 1” and “Tigers” can be more granular than the content tags for “Car Racing” and “Wildlife.” Further, in this example, the content tags for “Formula 1” and “Tigers” can be of the same level of granularity. Based on the more granular content tags, the user interests of the user can be determined to be or include “Formula 1” and “Tigers.” Further, a watch time of the user for content with the “Formula 1” content tag can be compared with a watch time of the user for content with the “Tigers” content tag to determine if the user is more interested in “Formula 1” or “Tigers.” Without identifying the more granular content tags and comparing the watch times of the user, it may be inaccurately or mistakenly determined that, for example, the user is equally interested in “Car Racing,” “Formula 1,” “Wildlife,” and “Tigers.” By using hierarchical and granular content tags associated with content the user consumes and watch times associated with how long the user consumes the content, an improved understanding of the user interests of the user can be made.

Content Tagging for Interest Targeting

The technology disclosed herein allows for improved interest targeting based on hierarchical and granular content tags. For example, based on hierarchical and granular content tags, recommendations for content that have content tags associated with specific or niche interests can be provided to a user based on an interest of the user in content that have content tags associated with a broad interest under which the specific or niche interests fall. When the user is determined to have an interest in content that have content tags associated with a broad interest (e.g., based on watch times of the content the user consumed), content that have content tags associated with specific or niche interests below the broad interest can be identified. The content that have content tags associated with the specific or niche interests can be provided to the user as recommendations as a way for the user to explore more granular interests. Based on how the user consumes the recommended content, specific or niche interests can be determined for the user. For example, a user can be determined to have an interest in content that have content tags for “Car Racing.” Based on the user's interest in content that have content tags for “Car Racing,” the user can be provided with recommendations for content that have content tags for more granular interests under “Car Racing,” such as “Motorcycle Racing” or “Formula 1.” Based on how the user consumes the content that have content tags for the more granular interests, it can be determined, for example, that the user is more interested in “Formula 1” than “Motorcycle Racing.” Based on the user's interest in “Formula 1” over “Motorcycle Racing,” the user can be provided with more recommendations for content that have tags for “Formula 1” instead of, for example, “Motorcycle Racing.” In some cases, a granular interest may be associated with more granular interests below the granular interest. In these cases, the more granular interests can be explored by providing recommendations for content that have content tags associated with the more granular interests to the user. For example, if “Formula 1” is associated with more granular interests below “Formula 1,” content that have tags associated with the more granular interests below “Formula 1” can be provided as recommendations to the user. Based on how the user consumes the content recommended to the user, a more granular interest can be determined for the user. Recommendations for content that have tags associated with the more granular interest can be provided to the user.

Content Tagging for Interest Signal Mining

The technology disclosed herein allows for ranking content for recommendations based on hierarchical and granular content tags. In general, content can reflect a variety of interests and the variety of interests can be expressed in quantitative terms. For example, content can reflect a broad interest and granular interests that fall under the broad interest can be expressed quantitatively. In some cases, a quantitative expression of a granular interest can be represented as a percentage, a fraction, a proportion, or other numerical representation. For example, a video that reflects a broad interest of “Baking” can reflect a quantity of granular interest of “Cakes” at 80% (or 0.8) and reflect a quantity of granular interest of “Cake Decorating” at 20% (or 0.2). The technology disclosed herein allows for weighting user engagement with content based on different quantities of granular interests reflected in the content. In an example, recommendation candidates for content to provide to a user can be ranked based on the weighted user engagement. Recommendations for content can be provided to the user based on the ranking. Based on how the user engages with the recommended content, additional recommendation candidates for content to provide to the user can be generated. The additional recommendation candidates can be ranked based on the user engagement with the recommended content weighted by the different quantities of granular interests reflected in the recommended content. Based on the ranking, additional recommendations for content can be provided to the user.

For example, a user can be determined to be interested in content with content tags for the broad interest of “Baking.” In this example, granular interests of “Cakes,” “Pastries & Pies,” and “Cupcakes” fall under the broad interest of “Baking.” Recommendation candidates for content with content tags for “Cakes,” “Pastries & Pies,” and “Cupcakes” can be generated for the user. The recommendation candidates can be ranked based on how the user engaged with the content with content tags for “Baking” and quantities of granular interests reflected in the content. For example, it may be determined that, when content is associated with multiple content tags, the user more often chose to consume content that reflect a quantity of granular interest associated with “Cakes” that is greater than quantities of granular interest associated with “Pastries & Pies” and “Cupcakes.” Accordingly, the recommendation candidates for content with content tags for “Cakes” can be ranked higher than the recommendation candidates for content with content tags for “Pastries & Pies,” and “Cupcakes.” Based on the ranking, recommendations for content with content tags for “Cakes” can be provided to the user. In this example, there are content tags for more granular interests of “Cake Decorating,” “Wedding Cakes,” and “Birthday Cakes” that fall under the relatively broader interest of “Cakes.” Additional recommendation candidates for content with content tags for “Cake Decorating,” “Wedding Cakes,” and “Birthday Cakes” can be generated for the user. The additional recommendation candidates can be ranked based on how the user engaged with the recommended content with content tags for “Cakes” and quantities of granular interests reflected in the recommended content. For example, it may be determined that the user more often chose to consume the recommended content with content tags for “Cake Decorating” than the recommended content with content tags for “Wedding Cakes” and content with content tags for “Birthday Cakes.” Accordingly, the additional recommendation candidates for content with content tags for “Cake Decorating” can be ranked higher than the additional recommendation candidates for content with content tags for “Wedding Cakes ” and “Birthday Cakes.” Based on the ranking, additional recommendations for content with content tags for “Cake Decorating” can be provided to the user. Many variations are possible.

### Context Based Group Naming and Message Grouper and Summarizer

Keywords: messaging, chat, groups, recommendations, names, machine learning, threads, features, grouping, topics.

Context Based Group Naming

A system, such as a social networking system, communication platform, or content sharing system, can provide communication tools that enable users to exchange messages with other users. For example, a user can send a message to another user through the system. The other user can receive the message and send a response through the system. In some cases, the system can provide communication tools that enable users to exchange messages in a messaging group. Users who are members of the messaging group can send messages to the messaging group, and the users in the messaging group can receive and reply to the messages that were sent. In many situations, a user can be a member of multiple messaging groups. Each messaging group can be related to different topics and include different users. Yet, messaging groups often are difficult to distinguish from one another. As a result, a user can be unsure about how to appropriately participate in a particular messaging group or, worse yet, can participate in a messaging group in a manner that is inconsistent with the goals or purposes of the messaging group. Accordingly, membership in various messaging groups can pose challenges for a user. This challenge can become exacerbated as the number of messaging groups in which the user participates increases.

The technology disclosed herein provides for generating recommendations for naming a group, such as a messaging group. The recommendations can be generated based on machine learning methodologies. The technology disclosed herein can use a generative model to generate recommendations for naming a messaging group based on various contexts. The contexts can include, for example, contexts associated with a user creating the messaging group and contexts associated with users in the messaging group. The recommendations can be provided to the user as part of a user experience flow in which the user creates a messaging group, adds users to the messaging group, and is provided with recommendations for naming the messaging group. By providing recommendations for naming a messaging group, the technology disclosed herein can reduce confusion associated with unnamed or unhelpfully named messaging groups as well as encourage use of group messages by reducing the burden in creating and using messaging groups.

Generative Model

The technology disclosed herein can provide for training a generative model, such as a machine learning model, to generate recommendations for naming a messaging group and applying the generative model to generate suggestions for a user creating a messaging group. The generative model can be trained with training data based on historical messaging groups. The training data can include contexts and related contextual information associated with messaging groups and names of the messaging groups. The contexts can be associated with, for example, social graph information associated with users in the messaging groups, messages exchanged within the messaging groups, and message histories associated with the users in the messaging groups (e.g., messages sent by the users to other users not in the messaging groups). The social graph information can include, for example, organizations, employment, education, hobbies, likes, dislikes, social connections and related affinities, and geographical locations associated with the users. The messages exchanged within the messaging groups and the message histories associated with the users in the messaging groups can be also be indicative of, for example, organizations, employment, education, hobbies, likes, dislikes, social connections and related affinities, and geographical locations associated with the users. The contextual information can be determined from various sources, such as a database of a social networking system or communication platform. For example, a set of training data can include a hobby as a name selected for a messaging group. The set of training data can also include contexts associated with users in the messaging group. The contexts can indicate that the users in the messaging group share various commonalities such as shared interests or attributes, among which is the hobby. In this example, the training data can bias a generative model to weigh commonalities in hobbies more heavily than other commonalities in generating a recommendation for a name to apply to a messaging group. Other weights can be applied to the generative model based on other training data.

In some cases, a trained generative model can be further trained or refined based on other types of training data. The training data can include context associated with messaging groups created by a particular user and names applied to the messaging groups by the particular user. Based on the training data associated with the particular user, the trained generative model can be refined to generate recommendations in accordance with personal tendencies of the particular user. In some cases, a trained generative model can be further trained or refined based on feedback associated with users who received recommendations for names to apply to a messaging group. The feedback can include, for example, whether recommendations were followed by users, which of the recommendations were followed by the users, and which names not recommended by the generative model were applied by the users. Based on recommendations that were followed by users, a generative model can be further trained to relatively heavily weigh contexts associated with the recommendations. In cases where no recommendations were followed by users, the generative model can be further trained to relatively lightly weigh contexts associated with the absence of recommendations. In cases where names not recommended by the generative model were applied by the users, the generative model can be further trained to relatively heavily weigh contexts associated with the applied names.

A trained generative model can be applied to various contexts. The contexts can include, for example, contexts associated with a user creating a messaging group, users in the messaging group, message histories associated with the user creating the messaging group and the users in the messaging group, and messages exchanged in the messaging group. The contexts can be used by the trained generative model to generate recommendations for names to be applied to the messaging group. Initially, a user can create a messaging group without yet identifying the users who may become potential members of the messaging group. At this time, generation of recommendations for names to apply to the messaging group can be based on contexts related to message histories associated with the user creating the messaging group. After the user creates the messaging group, the user can add other users to the messaging group. At this time, generation of recommendations for names to apply to the messaging group can be further based on contexts related to message histories associated with the other users added to the messaging group. After the user creates the messaging group and adds the other users to the messaging group, the user can exchange messages with the other users in the messaging group. At this time, if a name has not already been applied to the messaging group, generation of recommendations for names to apply to the messaging group can be further based on contexts related to the messages exchanged between the users in the messaging group. When a user initially creates a messaging group, certain recommendations may be associated with a relatively lower confidence level of being accepted based on a relatively lower amount of contextual information available to the generative model. As the user adds users to the messaging group and messages are exchanged among the users in the messaging group, certain recommendations may be associated with a relatively higher confidence level of being accepted based on a relatively higher amount of contextual information available to the generative model. Recommendations can be provided to the user when the recommendations satisfy a threshold confidence level.

In some cases, a user can specify a class of names from which recommendations can be generated. Classes of names can include, for example, funny, serious, casual, formal, work-related, personal, etc. Based on a class of names specified by a user, a generative model can generate recommendations for names that are appropriate in tone and situation. For example, a user creating a messaging group can specify that recommendations for names to apply to the messaging group should be serious because the messaging group is work-related. A generative model can generate recommendations for names that have a serious tone and are appropriate for work. In some cases, a generative model can infer a class of names and generate recommendations for names in accordance with the inferred class of names. For example, a user creating a messaging group can add users that are employed by the same employer as the user. Based on the users in the messaging group, a generative model can infer that the messaging group is work-related and accordingly generate recommendations that are appropriate for work.

In some cases, a generative model can generate recommendations for names that include tags or other indicators. An indicator can indicate an identity or attribute of a messaging group, such as family, friends, co-workers, etc.; an event associated with the messaging group; a name of a work project associated with the messaging group; or other types of information relevant to the messaging group. For example, a user can create a messaging group for planning a family event. The user can add family members to the messaging group. Based on the users in the messaging group, a generative model can generate recommendations for names that indicate that the messaging group is for planning the family event. The recommended names can include a tag to indicate that the users in the messaging group are family members or that the messaging group is related to planning a family event.

User Experience

The technology disclosed herein can provide recommendations for names to be applied to a messaging group as part of a user experience flow. A user experience flow for creating a messaging group can include, for example, an interface for creating a messaging group, an interface for adding users to the messaging group, and an interface for exchanging messages with the users in the messaging group. Recommendations for names can be provided in any of these or other interfaces associated with the user experience flow. For example, a user can be presented with an interface for adding other users to a messaging group after a request to create the messaging group. As the user adds the other users to the messaging group, recommendations for names can be provided within the interface. As another example, a user can be presented with an interface for exchange messages with users in a messaging group. In this example, the messaging group can be yet unnamed or have an unhelpful name or other identifier, such as a partial or entire listing of the users in the messaging group. As the user types a message to exchange with users in the messaging group, recommendations for names can be provided within the interface.

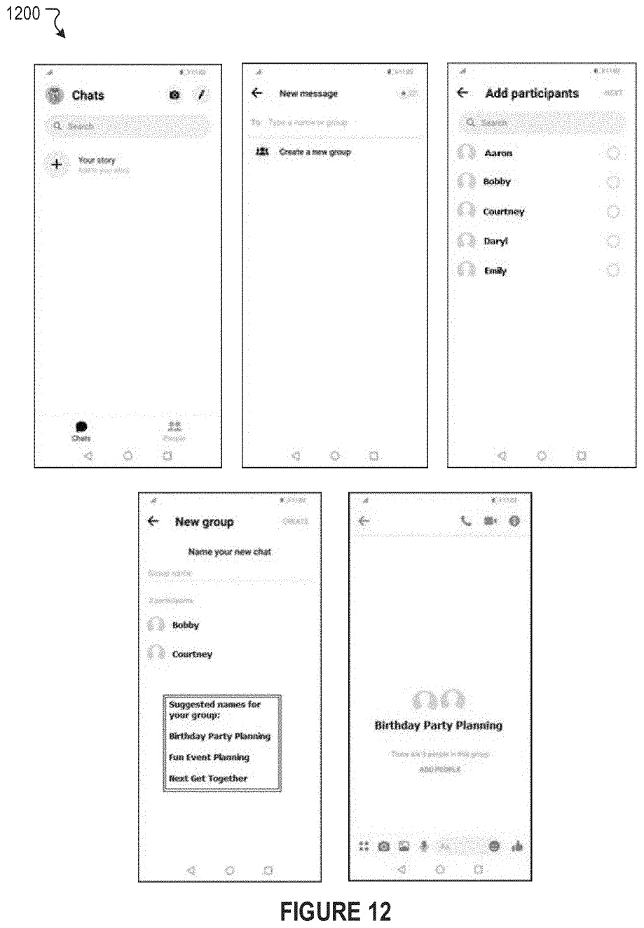

FIG. 12 illustrates an example user experience flow 1200 for creating a messaging group. In the example, an interface for exchanging messages (e.g., chats) is provided to a user. The user can, for example, interact with the pencil icon in this interface to access an interface for sending a new message or creating a new messaging group. The user can create a new messaging group by interacting with the “Create a new group” button. In response to this interaction, the user can be provided with an interface for adding users to the new messaging group. Once the user has added users to the new messaging group, the user can be provided with an interface for naming the new messaging group. Once the user has named the new messaging group (e.g., Birthday Party Planning), the user can send messages to the new messaging group. In this example, recommendations for names to apply to the new messaging group can be provided at any suitable points of the user experience flow. For example, recommendations for names determined by a generative model can be presented in an interface for naming the new messaging group when the interface first appears or when the user starts typing a name for the new messaging group, as shown. As another example, recommendation for names can be presented when the user starts typing a message to the new messaging group. In some cases, once a name has been applied to a messaging group, either through a recommendation or otherwise, a notification can be sent to users in the messaging group to inform the users in the messaging group of the name.

Message Grouper and Summarizer

A system, such as a social networking system, communication platform, or content sharing system, can enable users to communicate with one another. The users can communicate through posts or messages posted or exchanged through the system. For example, users of a system can text, message, or otherwise communicate through a dedicated messaging application provided by the system. In some cases, users can exchange messages in a group, such as a messaging group or chat. Users who are participants in a chat can send messages to other users in the chat, and the users in the chat can receive and reply to messages that were sent. Within a chat, there can be multiple conversation topics reflected in messages exchanged among users of the chat. For example, in a chat, there may be a conversation topic discussing dinner plans and another conversation topic discussing house chores. Messages associated with the different conversation topics may be interlaced, thereby making conversations in the chat disjointed and hard to follow for users in the chat.

The technology disclosed herein provides a computerized solution based on machine learning to organize messages of users in a group communication, such as a chat, so that conversations occurring in the group communication are easier to follow for the users. A machine learning model can be trained to group messages spanning various conversation topics in a group communication into one or more conversation threads. A conversation thread is a collection of messages that relates to a particular conversation topic. The machine learning model can group messages based on features associated with the messages. In some cases, the machine learning model can further generate a word or phrase summarizing each conversation thread as a possible label or identifier for the conversation thread. Thus, the disclosed technology improves user experience in group communications that may have interlaced messages reflecting different conversation topics.

Grouping Messages Based On Machine Learning Model

The technology disclosed herein can organize various messages in a group communication, such as a chat, into one or more conversation threads based on a machine learning model. In some embodiments, the machine learning model can be trained to group messages based on a similarity algorithm, such as a k-nearest neighbors (k-NN) technique. Messages can be represented as feature vectors. Features of the feature vectors and their associated values can be associated with various attributes of the messages. These feature vectors can be embedded in an embedding space and clustered. In general, the more similar messages are to each other, the closer their associated feature vectors are to each other in the embedding space. Therefore, feature vectors can be clustered into one or more clusters in an embedding space based on similarity of their features. Correspondingly, messages corresponding to feature vectors that have been clustered into a same cluster have similar attributes and, therefore, can be associated with a conversation thread.

Feature vectors representative of messages can be based on various attributes or features of the messages. These message features can include, for example, contextual features, textual features, participant features, timing features, and device features. Other types of message features are possible. As discussed, a machine learning model can cluster together feature vectors representative of messages that have similar message features. Messages represented by feature vectors in a same cluster can be associated with a particular conversation thread.

The contextual features can include words relating to a theme, subject matter, or other focus of a message. For example, a user can post a message “Let's bake pizza tonight” in a chat. In this example, a focus of the message can be “pizza” or, more generally, food. As another example, another user in the chat can post a message “Did you folks clean up the apartment?” In this example, a focus of the message can be “clean up” or, more generally, cleaning. Messages that have similar contextual features may be grouped together in a conversation thread by the machine learning model. For example, a first user can post a first message “Let's bake pizza tonight” in a chat. After the exchange of more messages in the chat, a second user can post a second message “Nah, I want a burger instead” in the chat. In this example, because a focus of the first message and a focus of the second message both relate to food (e.g., “pizza” and “burger,” respectively), feature vectors representative of the first message and second messages are relatively more likely to be clustered together.

The textual features can include information relating to a length of a message, words included in a message, whether a message is a question or remark, or other text-related attribute of a message. For example, a first message posted to a chat can comprise five words in length and a second message posted to the chat can comprise 500 words in length. In this example, feature vectors representative of the first message and the second message are relatively less likely to be clustered together based on the significant difference in word length. As another example, a first user can post a first message “Let's bake pizza tonight” in a chat. After the exchange of more messages, a second user can post a second message “No pizza. I want a burger instead” in the chat. In this example, because both messages include the word “pizza,” feature vectors representative of the messages are relatively more likely to be clustered together based on the similarity in textual features.

The participant features can include information relating to users that is specific to the relevant chat. For example, initial messages of a first user and a second user in a chat can be discussing food while initial messages of a third user in the chat can be discussing house chores. In this example, it is relatively more likely that all messages from the first user and the second user in the chat will be clustered together while all messages from the third user will be clustered separately. In some cases, the participant features can further include metadata information associated with media content items or links to media content items shared in the chat by users. For example, a first user can share a dog video in a first message and a second user can share a dog image in a second message. The dogs in the messages can be identified by corresponding tags or convention object recognition techniques. In this example, feature vectors representative of the messages involving dogs are relatively more likely to be clustered together based on their similarity.

The timing features can include timestamps relating to user interactions with messages in a chat. Timestamps can include, for example, times at which messages are sent or received by users in a chat and times at which messages are being typed by the users. Feature vectors representative of messages with sequential timestamps may be clustered together. For example, a first user can post a first message in a chat. A second user in the chat can receive the first message at a first timestamp (e.g., 3:15:43). While the second user is typing a second message at a second timestamp (e.g., 3:17:12-3:18:55) in response to the first message, the second user can receive a third message from a third user at a third timestamp (e.g., 3:18:45). In this example, feature vectors representative of the first message and the second message are relatively more likely to be clustered together because the first timestamp and the second timestamp are sequential. However, feature vectors representative of the second message and the third message are relatively less likely to be clustered together because the second timestamp and the third timestamp overlap—i.e., the second user is unlikely to be typing the second message in response to the third message.

The device features can include information that can be obtained from computing devices used to participate in a chat. For example, in some embodiments, a front-facing camera of a computing device operated by a user can be used to monitor a gaze of the user while the user types a message in a chat. The computing device, based on the gaze, can determine messages the user looked at prior to typing the message. In this example, the message the user is typing is likely in response to the messages the user looked at prior to typing. Therefore, a feature vector of the message the user is typing is relatively more likely to be clustered together with feature vectors of the messages the user looked at. Many variations are possible.

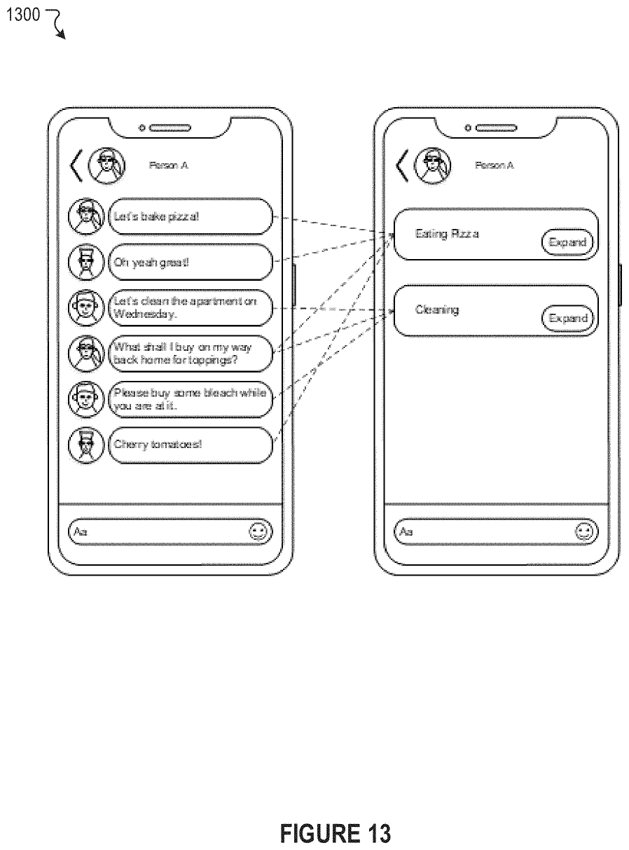

FIG. 13 is an example diagram 1300 illustrating grouping of messages in a chat into applicable conversation threads associated with particular conversation topics. As shown in FIG. 13, the chat includes messages related to various conversation topics that are interlaced in a single conversation thread, thereby making the messages hard to follow. By utilizing the technology disclosed herein, the messages can be grouped into multiple conversation threads so that conversation is easier to follow. For example, as shown in FIG. 13, messages in the chat can be grouped into two conversation threads based on the machine learning model, with one conversation thread including messages relating to pizza and another conversation thread including messages relating to apartment cleaning. In some embodiments, a summarizing model based on deep learning can be used to analyze messages in a conversation thread to determine words or phrases that summarize the conversation thread. For example, the summarizing model can be based on a natural language model utilizing a bag-of-words representation. The summarizing model can output one or more salient terms most representative of the messages in the conversation thread. These terms can be used as labels or identifiers for a corresponding conversation thread. In FIG. 13, the summarizing model determines the words “eating pizza” to be most representative of the conversation thread relating to pizza and the word “cleaning” to be most representative of the conversation thread relating to apartment cleaning.

In some embodiments, the one or more conversation threads can be presented through an interface that includes an element that, upon selection, can reveal messages included in the one or more conversation threads. For example, as shown in FIG. 13, the conversation thread relating to eating pizza can include an “Expand” element that when selected causes the conversation thread to expand to reveal messages relating to the conversation thread. Similarly, the conversation thread relating to cleaning can also include an “Expand” element that when selected causes the conversation thread to expand to reveal messages relating to the conversation thread.

Classifying New Messages Into One Or More Conversation Threads

In addition to the machine learning model grouping various messages in a chat into one or more conversation threads, the machine learning model can be further configured to output scores for each new message that is posted to the chat. A score outputted by the machine learning model can be a measure of similarity of a new message to an existing conversation thread. For example, a new message can be posted to a chat that has been determined by the machine learning model to include two conversation threads. In this example, the machine learning model can output a score for the new message for each of the two conversation threads. Each score indicates a similarity of the new message to each of the two conversation threads. The machine learning model then can classify the new message into the conversation thread with the higher corresponding score.

In some embodiments, scores of a new message can be determined based on distances of a feature vector representative of the new message to centroids of one or more clusters of feature vectors corresponding to the one or more existing conversation threads in an embedding space. By determining distances of the feature vector representative of the new message to the one or more clusters in the embedding space, scores of the new message to the one or more existing conversation threads can be determined. In one implementation, the higher a score of a new message in relation to an existing conversation thread, the more likely the new message is part of the existing conversation thread.

In some embodiments, scores of a new message must satisfy a selected threshold value in order for the new message to be included in an existing conversation thread. For example, a chat can have two existing conversation threads and a user in the chat can post a new message to the chat. In this example, the machine learning model may output scores of 0.71 and 0.69 for the new message in relation to the first conversation thread and the second conversation thread, respectively. In one example, a threshold value to associate a new message with an existing conversation thread can be 0.7. In this example, because the score of 0.71 exceeds the threshold value, the new message can be included in the first conversation thread. In some cases, multiple scores of a new message in relation to multiple conversation threads can satisfy a threshold value. In such cases, the new message can be included in all applicable conversation threads. For example, as before, a threshold value to associate a new message with an existing conversation thread can be 0.7. In this example, a machine learning model can output scores of 0.71 and 0.82 for the new message for two existing conversation threads, respectively. In this example, the new message is associated with both existing conversation threads. In some embodiments, if scores of a new message do not satisfy a threshold value for any existing conversation threads, a new conversation thread can be created based on features of the new message. For example, the machine learning model can output scores of 0.51 and 0.63 for the new message for two existing conversation threads, respectively. In this example, if neither score satisfies the threshold value, instead of associating the new message with the two existing conversation threads, the machine learning model may create a new conversation thread for the new message.

### Adaptive Bitrate Video Delivery

Keywords: video, video streaming, adaptive bitrate streaming, content delivery.

A content platform or system, such as a social networking system, can enable access to content, such as images, videos, articles, and links. The content can be streamed to users via the system. For example, a video can be published through a social networking system, and users can stream the video through the social networking system. The users can access the video as the video is delivered through the social networking system in real-time or near real-time without waiting for the video to be fully downloaded. Streaming can involve various challenges, such as a lack of sufficient bandwidth resulting in stops, lags, or slow buffering of content.

The technology disclosed herein provides for improved content streaming. The technology disclosed herein utilizes a content delivery architecture that provides for server-centered adaptive bitrate streaming. The content delivery architecture can provide streams of content where a server determines which stream of content to provide and determines where in the stream of content to switch to a different stream of content. The content delivery architecture can also provide for low latency streams by controlling transmission and retransmission of data in the streams of content. The content delivery architecture utilizes containers that maintain usability of a content file when the content file is missing data. The containers facilitate playback of content in the content file despite the missing data and also facilitate repair of the content file.

Adaptive Bitrate Video Delivery

The technology disclosed herein can provide for server-centered adaptive bitrate streaming. In server-centered adaptive bitrate streaming, a server system maintains content to be streamed to client devices. The content can be maintained as multiple alternative streams of content, with each stream of content corresponding to a different quality (e.g., 360p, 720p, 1080p, 4K, SD, HD, etc.) or bitrate (e.g., 800 kbps, 1200 kbps, 1500 kbps, 4000 kbps, etc.). A client device can request content from the server system, for example, with an HTTP request. In response to the request, the server system streams the requested content to the client device. The server can initially select a first stream of multiple streams of the requested content and provide the first stream to the client device. The initial selection can be based on various factors. The factors can be associated with network connectivity (e.g., available bandwidth, type of network connection, etc.). The factors can also be associated with device capabilities (e.g., screen size, display resolution, device type, processing capabilities, etc.) of the client device. The factors associated with the client device can be provided to the server system by the client device. The other factors, such as those associated with network connectivity, can be determined by the server system. The server can select a second stream of the multiple streams of the requested content based on changes to the various factors. For example, the server can select a stream corresponding to a lower quality or a lower bitrate in response to a decrease in available bandwidth.

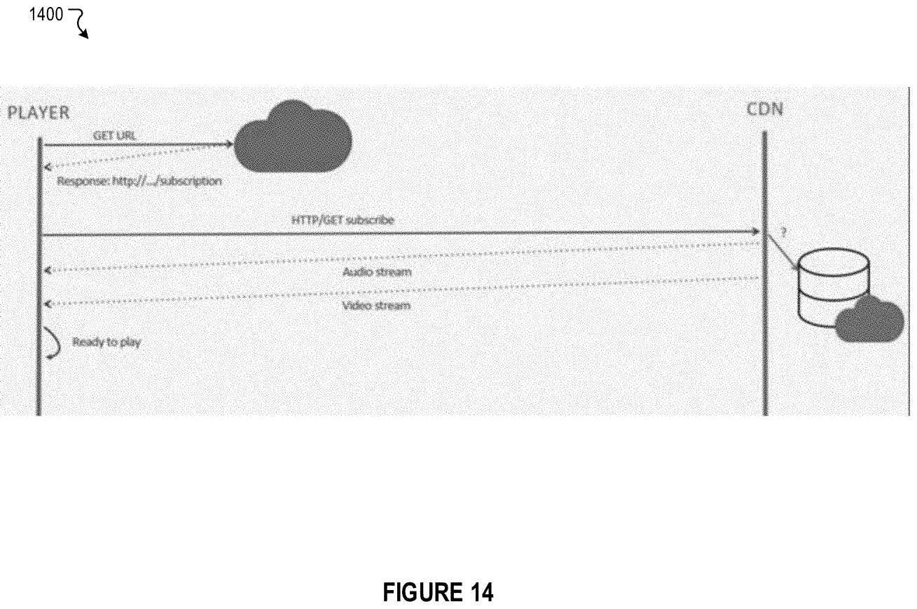

FIG. 14 illustrates an example diagram 1400 involving a client device (e.g., player) sending a request for content to a server system (e.g., content delivery network (CDN)). In the example, the client device sends a GET URL request and receives a URL of the server system in response. The client device sends a HTTP/GET subscribe request to the server system for content (e.g., movie). In response, the server system sends an audio stream and a video stream to the client device. The client device can play the content based on the received audio stream and the received video stream.

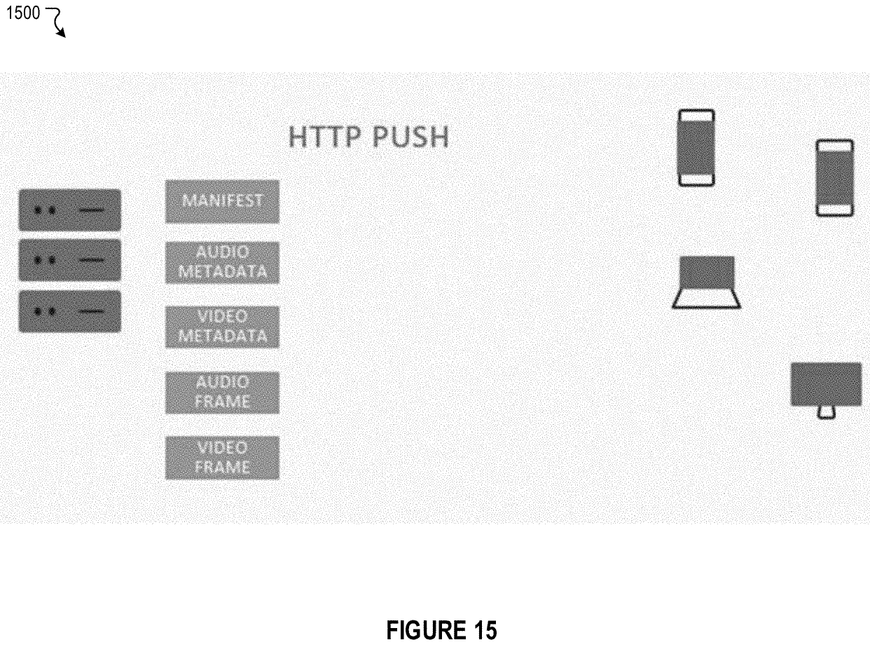

FIG. 15 illustrates an example diagram 1500 involving a system server providing a stream of content to one or more client devices. In the example, the system server uses an HTTP PUSH mechanism to deliver a manifest, audio metadata, video metadata, one or more audio frames, and one or more video frames associated with the stream of content.

Server-centered adaptive bitrate streaming of the disclosed technology allows for improved switching between streams of content. In general, switches from one stream of content to another stream of content occur at switch points. These switch points generally correspond with segments of content. For example, streams of content can be divided into segments (e.g., 0.5 second segments, 2 second segments, 10 second segments, etc.). A switch point can correspond with where a first segment of a first stream of the streams of content ends and a second segment of the first stream of content begins. In cases where the streams of content follow the same segmentation scheme (e.g., all segments are 2 second segments), switches between a first stream of content to a second stream of content can occur at switch points that correspond with where a first segment associated with the first stream of content ends and a second segment associated with the second stream of content begins. Because the first stream and the second stream follow the same segmentation scheme, playback of the content can appear uninterrupted when the switch from the first stream of content to the second stream of content occurs. In general, a switch between streams of content that occurs outside a switch point can result in suboptimal playback that appears interrupted.

In server-centered adaptive bitrate streaming of the disclosed technology, a server system can switch between streams of content based on multiple segmentation schemes involving segments of variable sizes. The server system can maintain streams of content and, for each stream of content, maintain different segmentation schemes for the stream of content. For example, a stream of content can be divided based on a first segmentation scheme (e.g., 2 second segments), and the stream of content can also be divided based on a second segmentation scheme (e.g., 0.5 second segments). The server system can switch between streams of content outside a switch point associated with the first segmentation scheme by switching to the stream of content divided based on the second segmentation scheme. For example, a first stream of content can be divided based on a first segmentation scheme (e.g., 2 second segments) and a second segmentation scheme (e.g., 0.5 second segments). A second stream of content can also be divided based on the first segmentation scheme (e.g., 2 second segments) and the second segmentation scheme (e.g., 0.5 second segments). In this example, the first stream of content divided based on the first segmentation scheme can be provided to a device. A switch can occur from the first stream of content to the second stream of content in the middle of a first segment (e.g., 2 second segment) of the first stream of content by switching to a second segment (e.g., 0.5 second segment) of the second stream of content. A subsequent switch can occur from the second stream of content divided based on the second segmentation scheme (e.g., 0.5 second segments) to the second stream of content divided based on the first segmentation scheme (2 second segments) at a switch point where the end of a third segment (e.g., 0.5 second segment) of the second stream of content divided based on the second segmentation scheme corresponds with the start of a fourth segment (e.g., 2 second segment) of the second stream of content divided based on the first segmentation scheme. In this example, playback of the content when the switches occur can appear uninterrupted. In general, a longer segment of content can have more efficient compression and require less bandwidth to stream than a shorter segment of content. By utilizing the switching described herein, a server system provides for flexible switching between streams of content while efficiently using bandwidth.

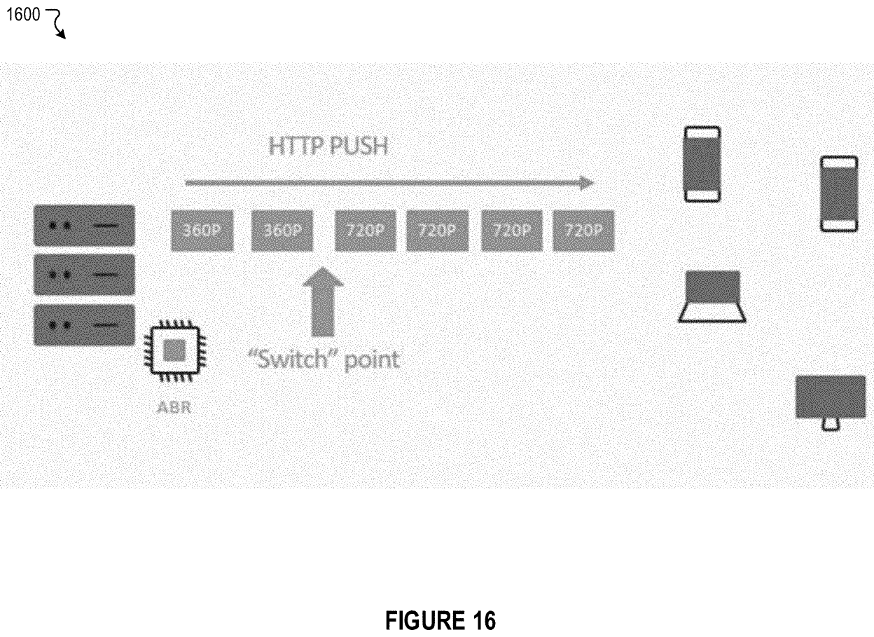

FIG. 16 illustrates an example diagram 1600 involving switching between streams of content. In the example, a switch occurs from a first stream of content (e.g., 360P) to a second stream of content (e.g., 720P). The switch occurs at a switch point that corresponds with when a first segment of the first stream of content ends and a second segment of the second stream of content starts. As described herein, switching at a switch point allows for playback of the content to appear uninterrupted.

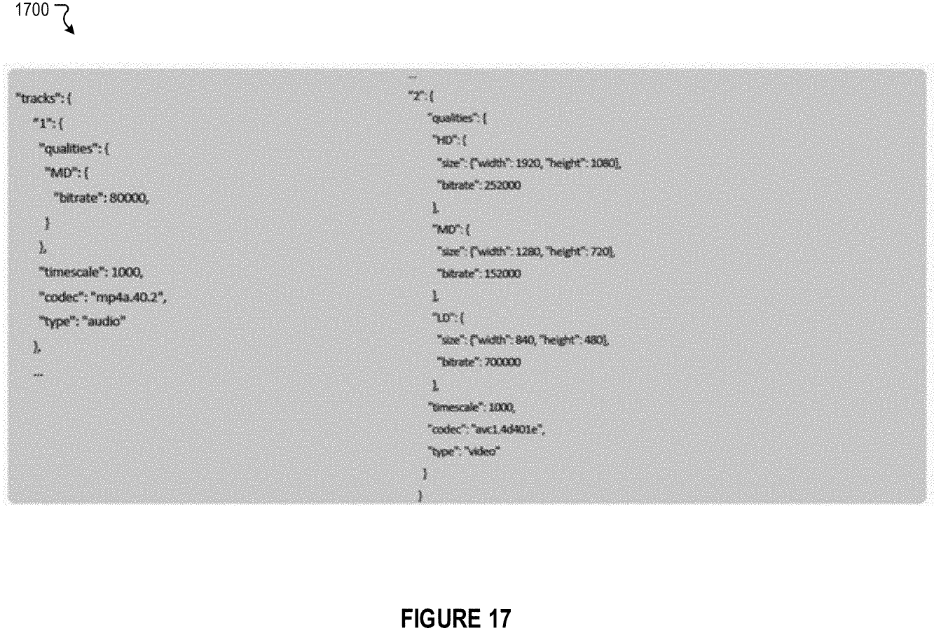

FIG. 17 illustrates an example manifest 1700 associated with a stream of content. A client device can use the manifest to request a stream of content corresponding to a particular quality (e.g., MD, LD). The client device can also use the manifest to determine certain characteristics (e.g., timescale, codec) associated with the stream of content.

Frame Latency Control

The technology disclosed herein can provide for low latency streams of content by controlling transmission and retransmission of data in the streams of content. In general, a stream of content is transmitted to a client device one portion at a time. In some cases, the transmission of the portion of the stream of content may fail. In these cases, the portion of the stream of content is retransmitted. The retransmission repeats until the portion of the stream is successfully transmitted to the client device. A low latency stream of content can be provided by setting a timer for each frame (e.g., video frame, audio frame, data frame, etc.) of the stream of content. The timer can indicate an amount of time to be allotted for transmission and retransmission of the frame. If the frame has not been successfully transmitted by the time the amount of time has passed, then further retransmissions of the frame are cancelled. The timer can be set for a frame based on various factors such as a type of the frame and dependencies associated with the frame. For example, in a video stream, transmission of keyframes (e.g., I-frames) can be prioritized over dependent frames (e.g., p-frames, b-frames) associated with the keyframes. The keyframes can be prioritized, for example, because the dependent frames cannot be completely decoded without information in the keyframes. In this example, a timer for the keyframes can be longer than a timer for the dependent frames. Accordingly, the keyframes are allotted a longer amount of time for transmission and retransmission than dependent frames. The longer amount of time can be associated with a higher likelihood of successful transmission of the keyframes. In some cases, the timer can also be set for a frame based on what has already been transmitted. For example, if a keyframe has been successfully transmitted, then preceding keyframes that have not been successfully transmitted can be cancelled. Dependent frames that depend on the preceding keyframes can also be cancelled as they depend on cancelled keyframes. Cancelling transmission of frames, as described herein, can efficiently utilize available bandwidth by prevented repeated attempts to transmit a frame that may no longer be useful.

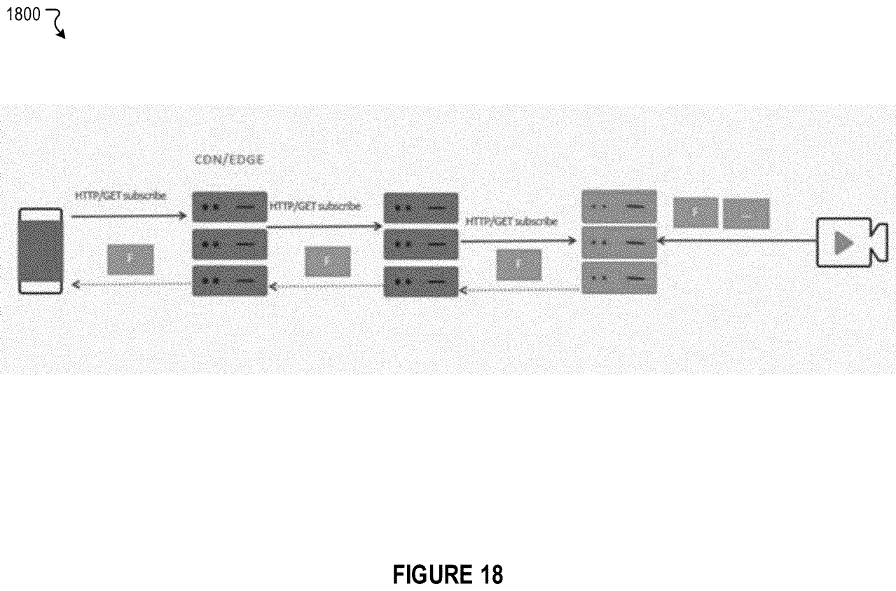

FIG. 18 illustrates an example diagram 1800 involving a client device sending a request for content to a server system and receiving a frame in response to the request. In the example, the client device sends a HTTP/GET subscribe request to the server system. The server system in this example can include an EDGE server of a CDN, an ORIGIN server of the CDN, and a LIVE server. The server system can receive live content from a capture device. In this example, the HTTP/GET subscribe request is received by the EDGE server, passed to the ORIGIN server, and passed to the LIVE server. In response, the LIVE server receives and transmits a frame of live content from the capture device. The frame is transmitted to the ORIGIN server, transmitted to the EDGE server, and transmitted to the client device. As described herein, the transmission of the frame may fail and, after an allotted amount of time has passed, the transmission of the frame may be cancelled.

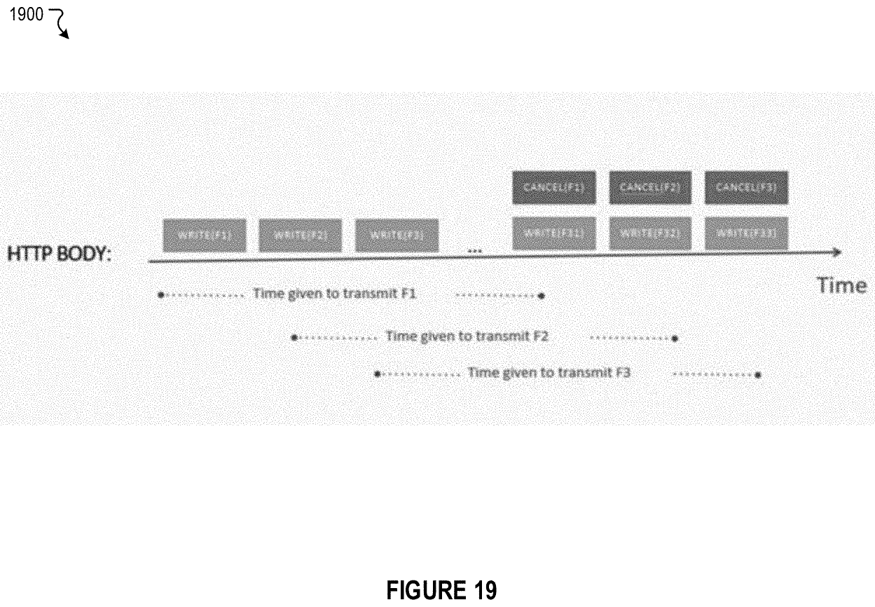

FIG. 19 illustrates an example diagram 1900 involving transmission of multiple frames. In the example, a first frame (e.g., F1), a second frame (e.g., F2), and a third frame (e.g., F3) are transmitted. The first frame is allocated a first amount of time for transmission. The second frame is allocated a second amount of time for transmission. The third frame is allocated a third amount of time for transmission. Following the first amount of time, a fourth frame (e.g., F31) is transmitted along with a cancel request for the first frame. Following the second amount of time, a fifth frame (e.g., F32) is transmitted along with a cancel request for the second frame. Following the third amount of time, a sixth frame (e.g., F33) is transmitted along with a cancel request for the third frame. Cancelling the failed transmission of the first frame, the second frame, and the third frame can provide for more available bandwidth for the transmission of the fourth frame, the fifth frame, and the sixth frame.

Partial Reliability Container

The technology disclosed herein allows for maintaining usability of a content file when the content file is missing data. During transmission of a content file, portions of the content file may fail to transmit or be dropped. Usability of the content file can be maintained by using a container that includes the content file and metadata associated with the content file. The metadata can be associated with the content file on a per frame basis (e.g., one set of metadata for one frame). The metadata can include, for example, frame dependencies, frame types, frame number, and other information associated with a frame. The metadata can be attached to the frame and transmitted along with the frame. In cases where a frame of a content file is dropped, for example, due to the frame failing to transmit, metadata of other frames in the content file can be used to determine that the frame failed to transmit and determine how that frame relates to other frames in the content file. For example, a client device may receive two frames of a content file and metadata associated with the two frames. The metadata can indicate that the two frames are frame one and frame five of the content file. Based on the metadata, the client device can determine that frames two, three, and four were dropped. The metadata can also indicate dependencies associated with the two frames and allow the client device to play back the two frames at least partially despite the dropped frames. In some cases, the client device can use the metadata to request the dropped frames to repair the content file received by the client device.

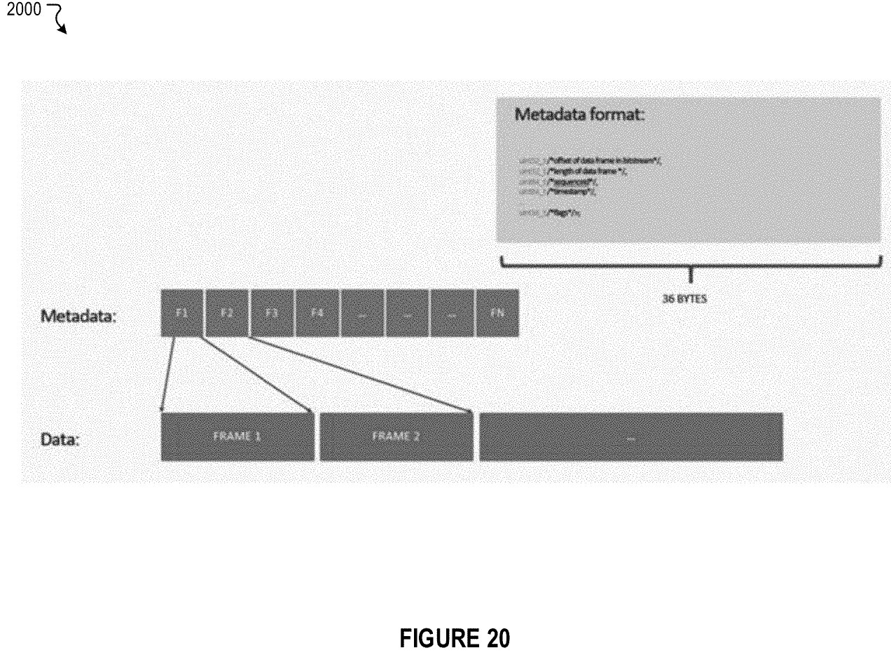

FIG. 20 illustrates an example diagram 2000 involving a container with data and associated metadata. The container includes frames (e.g., FRAME 1, FRAME 2), and the metadata (e.g., F1, F2) is associated with each frame. In the example, the metadata for a frame includes an offset of the frame in a stream, the length of the frame, a sequence number of the frame, a timestamp of the frame, and tags of the frame.

### Scope of Disclosed Technology

Certain details in this disclosure are set forth in order to provide an understanding of various embodiments of the technology that is disclosed. A reference herein to an “embodiment”, “instance”, “example”, or the like are not necessarily all referring to the same embodiment. Nor are separate or alternative embodiments mutually exclusive of other embodiments. Various features are herein provided or described through text and diagrams. The features may be variously combined and included in some embodiments, but also variously omitted in other embodiments. Similarly, various features are described that may be preferences or requirements for some embodiments, but not for other embodiments. Accordingly, the disclosure of the embodiments of the technology is intended to be illustrative, but not limiting, of the scope of the technology. The features of the disclosed technology may be variously combined, separated, removed, reordered, or replaced in a manner other than as expressly described and depicted herein.

The disclosed technology can be categorized in one or more technical fields. The disclosed technology can be appropriately combined with other technologies categorized in the same technical fields in which the disclosed technology can be categorized. Further, the disclosed technology can be appropriately combined with other technologies in technical fields that are different from the technical fields in which the disclosed technology can be categorized. The disclosed technology has broad application to other technologies and other technical fields, and can be appropriately implemented, adjusted, modified, or combined therewith.

What is claimed is:

1. A computer-implemented method comprising:
determining, by a computing system, a type of viewer selected by an owner of a post;
determining, by the computing system, a type of owner associated with the owner of the post; and
determining, by the computing system, a viewer can provide a comment to the post based on the type of viewer and the type of owner.

2. The computer-implemented method of claim 1, wherein the type of owner includes a blue badge public figure or a non-blue badge public figure and the type of viewer includes at least one of followed profile or page, tagged profile or page, or blue badge public figure.

3. The computer-implemented method of claim 1, further comprising:
determining, by the computing system, a type of action taken on the comment by a type of actor; and
providing, by the computing system, a type of view of the comment based on the type of viewer, the type of action, and the type of actor.

4. The computer-implemented method of claim 3, wherein the type of view is at least one of visible on separate surface, no effect, remove feature, remove delete for blue badge comments, or comment deleted.

5. The computer-implemented method of claim 1, further comprising:
providing, by the computing system, an option to hide comments in a first listing; and
relocating, by the computing system, the comments from the first listing to a second listing of hidden comments.

6. A computer-implemented method comprising:
determining, by a computing system, a content tag associated with a content item accessed by a user;
generating, by the computing system, an embedding associated with the content tag; and
determining, by the computing system, an interest associated with the user based on the embedding.

7. The computer-implemented method of claim 6, wherein the interest associated with the user is determined further based on a level of granularity associated with the content tag.

8. The computer-implemented method of claim 6, wherein the interest associated with the user is determined further based on a watch time associated with the content item accessed by the user.

9. The computer-implemented method of claim 6, further comprising:
generating, by the computing system, a set of candidate recommendations based on the interest associated with the user;
ranking, by the computing system, the set of candidate recommendations based on a weighted user engagement associated with the content item accessed by the user; and
providing, by the computing system, a recommendation based on the ranking.

10. The computer-implemented method of claim 6, wherein the generating the embedding associated with the content tag comprises:
training, by the computing system, a model based on training pairs of content tags and co-occurrences associated with the training pairs of content tags.

11. A computer-implemented method comprising:
determining, by a computing system, contexts associated with a user that has created a messaging group;
generating, by the computing system, a recommendation for a name to apply to the messaging group based on the contexts associated with the user; and
providing, by the computing system, the recommendations to the user.

12. The computer-implemented method of claim 11, further comprising:
determining, by the computing system, contexts associated with other users added to the messaging group, wherein the recommendation for the name to apply to the messaging group is further based on the contexts associated with the other users.

13. The computer-implemented method of claim 11, further comprising:
determining, by the computing system, one or more messages exchanged in the messaging group, wherein the recommendation for the name to apply to the messaging group is further based on the one or more messages.

14. The computer-implemented method of claim 11, wherein the generating the recommendation for the name is based on a machine learning model, wherein the machine learning model is trained based on contexts associated with past messaging groups and names applied to the past messaging groups.

15. The computer-implemented method of claim 14, wherein the machine learning model is further trained based on contexts associated with past messaging groups created by the user and names applied to the past messaging groups created by the user.
